(19) United States
(12) Patent Application Publication
(10) Pub. No.: US 2023/0042458 A1
(43) Pub. Date: Feb. 9, 2023

(54) DATA PROCESSING FOR SPEND CONTROL AND BUDGET MANAGEMENT

(71) Applicant: NB Ventures, Inc., DBA GEP, Clark, NJ (US)

(72) Inventors: Subhash Makhija, Westfield, NJ (US); Ashwin Kumar Dileep Kumar, Washington DC, DC (US); Darren Lynch, Eindhoven (NL); Piyush Singla, Woodbridge, NJ (US); Swetha Thomson Arimpur, Chennai (IN); Garima Kansal, Haryana (IN); Tina Vaz, Dombivli (East) (IN); Vinay Bhat, Pinner (GB); Kumar Shah, Gujarat (IN)

(21) Appl. No.: 17/394,067

(22) Filed: Aug. 4, 2021

(51) Int. Cl. G06Q 40/00; G06F 30/27; G06F 9/451

(52) U.S. Cl. CPC G06Q 40/12; G06F 30/27; G06F 9/451

(57) ABSTRACT

The present invention provides a system and a method of data processing for spend control and budget management in enterprise application. The data processing includes tracking, monitoring, and analyzing one or more datasets of a plurality of entities in real time. The system processes one or more data attributes associated with the received data objects based on one or more data models and determines an impact of the received data object on a data control tower through a data simulation thereby enabling informed readjustment of the data control tower.

### BACKGROUND

### 1. Technical Field

The present invention relates generally to enterprise applications. More particularly, the invention relates to Artificial Intelligence based system and method for spend control and budget management in Supply chain management (SCM) enterprise application.

### 2. Description of the Prior Art

Managing budgets for any organization is a tedious task, particularly when the organization is structured with multiple sub entities and functions carrying out expenses over a period. The organizations often rely on computer-based systems to manage the budgets and expenses. Conventional financial management systems allow organizational users to create and manage budgets through a static process. Such systems do not track real time budget and expense data because of the complexity involved in predicted expenses and actual expenses. Moreover, the system is unable to accommodate for modifications to data objects such as purchase orders, invoices etc., that may impact the overall budget for the organization.

One prior art Patent US10402896B1 discloses a system and method for financial categorization and budgeting of a user. The Prior art discloses categorizing of personal budgets through the account for managing it and reflecting the categorization of transactions through the user interface. However, the prior art has limitation of the data being processed for an individual's budget in comparison to an organizational budget which needs to be tracked by monitoring multiple sub entities. Moreover, the organizational expenses are executed through a channelized process of generating data templates like purchase orders, invoices etc., that may require multiple protocols to process each type of template document.

The complexity involved in processing any change for one or more entities of an organization and to reflect the impacted yearly or quarterly or daily budget due to the change is impossible to track. Further, due to unavailability or real time data, the budgets are often under-utilized or spilled over to accommodate urgent procurement needs. The systems are unable to accommodate sudden changes or requirements while maintaining the overall set budget for the year due to technical limitations in processing such information in real time. The existing systems and method have inherent limitations as training the system for directing the change throughout the budgeting system in real time requires enhanced processing capabilities or processing of data attributes that are not even evaluated with existing system and methods. Also; the existing systems do not provide real time visibility to the actual budget status at any time instant. Any discrepancy, in the budget data of one or more entities with respect to actual or probable expense that is altered due to practical procurement requirement in real time environment is not considered due to technical limitations of the existing systems.

None of the prior arts address the structural, processing complexity and technical issues in executing complex budgeting functions through an enterprise application that are supported by existing architecture designs and infrastructure.

In view of the above problems, there is a need for a system and method of data processing in enterprise application that can exploit computing resource capabilities to generate complicated real time visibility of spend and budget systems to overcome the problems associated with the prior arts.

### SUMMARY

According to an embodiment, the present invention provides a data processing system and method in Supply chain management application. The system includes a processor and one or more memory devices including instructions that are executable by the processor for causing the processor to track, monitor and analyze, by the processor coupled to a data tracker, one or more datasets of a plurality of entities in real time wherein the datasets stored in a real-time entity database are classified automatically by the processor based on attributes associated with the datasets to generate one or more classified datasets of at least one data control tower; receive one or more data objects from at least one entity of the plurality of entities; process by an Artificial Intelligence engine coupled to the processor, one or more data attributes associated with the one or more received data objects based on one or more data models stored in a data model database to automatically classify the one or more received data objects wherein the one or more data models are structured based on the one or more datasets; and determine an impact of the one or more received data objects on the data control tower through a data simulation thereby enabling informed readjustment of the one or more classified datasets and the data control tower.

In an embodiment, the data processing system and method causes the processor to automatically feed, the one or more received data objects to a first data model to obtain an output from the first data model indicating whether a data attribute value associated with the one or more received data objects is greater than or less than a threshold value associated with the data control tower.

In an embodiment, the data processing system and method causes the processor to automatically feed, the output from the first data model to a second data model to obtain an output from the second data model indicating an approval flow to be executed by the processor for the one or more received data objects.

In an embodiment, the data processing system and method causes the processor to, in response to receiving the output from the second data model, generate a visual data object within a graphical user interface (GUI) through the data simulation to provide guidance on the impact of the one or more received data objects on the at least one data control tower.

In an embodiment, the data processing system and method causes the processor to, automatically feed, an impact information to readjust the one or more classified datasets and the data control tower on execution of the approval flow.

In an embodiment, the data processing system and method causes the processor to generate a revised version of the at least one data control tower and render by the processor the revised version within the GUI.

In an embodiment, the data processing system and method causes the processor to automatically determine the threshold value for the data attribute value by analyzing a historical data of the real time entity database used to generate the one or more classified datasets and automatically render visual data markers within the GUI indicating the threshold value for the data attribute value.

In an embodiment, the data processing system and method causes the processor to, in response to determining the data attribute value as greater than the threshold value, automatically feed the impact information and the data attribute value to a third data model to obtain an output from the third data model indicating distribution of data attribute value over a time frame and generating by the processor a visible projection of the distribution within the GUI to provide the revised version of the data control tower.

In an embodiment, the present invention provides a computer program product for data processing in SCM enterprise applications of a computing device with memory. The product includes a computer readable storage medium readable by a processor and storing instructions for execution by the processor for performing the above method.

In an embodiment, the memory device of the present invention further includes instructions that are executable by the processor for causing the processor to generate training data using a plurality of historical datasets spanning one or more time-periods, wherein the training data includes readjusted data attribute values for the data points driven by change in data objects triggered by a user or automatically by the system, actual values for the data points gathered during the one or more time-periods, and an indication of whether the readjusted values are closer to the actual values than the predicted values.

In another embodiment, the memory device of the present invention further includes instructions that are executable by the processor for causing the processor to train a plurality of data models using the training data to enable the plurality of data models to determine whether a particular data attribute value provided to the data model is greater or lesser than the threshold value, determine accuracies of the plurality of data models using validation data, compare the accuracies of the plurality of data models to identify a most accurate data model among the plurality of data models; and select the most accurate data model as the first data model.

In yet another embodiment, the present invention provides a graphical user interface for a data processing system. The GUI includes a dashboard depicting an aggregated budget data projection over a period, the aggregated data projection being generated at least in part by aggregating a plurality of classified datasets related to budget, an input element for receiving user input associated with a data point in the approval or rejection action based on threshold values; a GUI object for presenting an impact analysis portion of the graphical user interface. Based on the input element, the system of the invention adjusts the aggregated budget data projection using the data point to generate an updated version of the aggregated budget data projection. The system renders an updated version of the data projection in the GUI, wherein the updated version of the graph visually depicts the updated version of the aggregated data projection of the data control tower. Further the system updates data points in the data projection by propagating an impact of any change in a data object through the data control tower.

Advantageously, the system and method of the present invention provides an enterprise web application for spend control and budget management. The application is hosted on cloud so it can be accessed by any browser on any desktop has a user-friendly GUI for creation and management of Budgets. The GUI renders means for execution of multiple budgetary and spend control operations.

In an embodiment, the data processing system of the invention is configured to map data object with a mapping data structure of threshold data ranges to resolution action, wherein the mapping data object maps a threshold data for a cost, quantity discrepancy pair to set of data script for resolution actions.

In an embodiment the data processing system and method of the present invention includes determining discrepancy of quantity, cost, tax parameters or other attributes of a data object due to real time changes driven by procurement or supply chain needs. In response to determination of discrepancy selecting a data script for executing changes to resolve the discrepancy by the processor resolution action and generating an electronic message that identified the resolution action. Further the system transmits via network communications, the electronic message to a processor to invoke the computing system to automatically perform the changes through the resolution action without any user intervention to resolve the attribute discrepancy including cost, quantity discrepancy. The resolution action includes adjusting at least one data value on the data control tower and the threshold value depending on the impact of the change.

In an embodiment, the data processing system matches one or more attributes of the received data object with historical datasets, with the matching action including performing at least one computerized comparison operation between the data attribute of the received data object and a plurality of historical dataset related to the data control tower to find the discrepancy based on at least one set of matching criteria.

It is an objective of the present invention to increase transparency of costs including direct cost or Indirect cost or any spend for one or more entities of an organization by tracking spends against annul budgets in real time through computing capabilities providing visibility across entities in the organization. The real time information from multiple systems including finance systems, Procurement systems etc., enables faster decision making and reduces complexity with decreased offline exchange of information. Also, providing appropriate control levers to manage budget consumption in an organization.

It is another objective of the present invention to set up one or more data control tower such as spend control tower, Direct cost or Indirect cost scope and budget data definitions. Also, the invention sets up Budget consumption mechanism by Actuals, Open purchase order (PO) data object, non-PO data object and Purchase request (PR) Pipeline. The system also creates budget control mechanisms for PR/PO approval workflows and request for re-allocation/additional budget requirements. The invention provides a real-time web-based reporting tool for easy access of above information for organization in data Control tower workstream.

Advantageously, the system and method of the present invention provide accurate budget consumption as the data objects including PR/PO records and invoice records are processes as a transient system of record until the accounting books are closed. The present invention includes protocols to amortize the data object in a manner to render real time budget consumption information. The AI engine considers attributes of data objects such as start data, end date, PR/PO type, currency, quantity, and cost to ensure the costs are captured as per financial Journal rules. Moreover, the evaluation of the above attributes to arrive at actual budget consumption provides accurate data for decision making in real time. Further, the system of the present invention evaluates, committed funds, actual funds and submitted funds in real time evaluation through the set of protocols. With submitted funds, PR and PO are separate data object records that allows the system to evaluate partial PO from the PR data object and allows for that differentiation for approval purposes so that budget consumption data in the data control tower considers actual available funds realizing some of the approved finds haven't been committed for release. When any data object such as the PR/PO record is modified, the funds are released, and rules are reapplied to capture the information in the change order. When any PO is closed, the remaining funds, after accounting for committed and actuals funds, are released back to the budget record. The approval rules allow for simple and complex approvals. The system first triggers a warning if a first threshold value is crossed to alert that the budget is nearing critical consumption level. When the second threshold is crossed, the system does not allow submission of PRs and a request for additional funds is to be made available through the system.

In an exemplary embodiment, the system is configured to process multiple options including moving budgets from another quarter, moving budgets from another cost center entity etc., to allow for additional funds to be made available. The system allows for movement of cost centres to accommodate changing organizational requirements such as mergers and acquisitions. When a cost centre is moved to a new budget entity, the associated costs and open POs are automatically mapped to the new budget entity to allow for accurate approvals.

In an advantageous aspect, the System is based on Cloud based technologies and configured for enterprise units and organizations across a network. Cloud Services collect and aggregate all orders, shipments, inventory, and status. Data linked to enterprise and external systems will provide global visibility. Using Intelligent analysis and AI, the one or more application provides insights to users with real-time status of shipment, delivery date, acknowledgement of PO, delay in shipment, inventory availability, transportation costs. Further, it provides insight from purchase to delivery for each good. The system monitors end to end activities thereby enabling real time changes in data control tower to reflect budget consumption. For any exceptions, alert/warning will be triggered along with recommendations. Accuracy of data Control Tower relies on consistency and timeliness of the data. Further, the system enables simultaneous mirror to entire network of all transactions posted to ledger. Data Control Tower will be able to authorize and collect the data and apply transformation rule Engine. The data Control Tower will receive data in real-time increasing accuracy, transparency, and consistency of the data. Transactions like Orders, requisitions, invoices etc., are recorded instantly. It will reduce integration complexity for enterprise systems and all participants in the network has visibility and operate on same data.

In an advantageous aspect, the system and method of the invention structures an approval workflow dynamically with model driven AI (artificial intelligence). Further, the present invention utilizes Machine Learning algorithms, artificial intelligence-based data processing for budget tracking, monitoring and analysis in real time to render accurate and informed execution decisions.

### BRIEF DESCRIPTION OF THE DRAWINGS

The disclosure will be better understood and when consideration is given to the drawings and the detailed description which follows. Such description makes reference to the annexed drawings wherein:

FIG. 1 is a flow chart depicting a data processing method for real time budget management in enterprise application in accordance with an embodiment of the invention.

FIG. 2 is data processing system configured for real time budget management in enterprise application in accordance with an embodiment of the invention.

FIG. 3 is a table depicting budget fund movement between expensed, obligated and committed database as transactions are created in the system in accordance with an embodiment of the invention.

FIG. 3A is a flow diagram depicting budget consumption of Purchase requisition in accordance with an embodiment of the invention.

FIG. 3B, is a table depicting budget consumption with PR for services and materials in accordance with an embodiment of the invention.

FIG. 3C, is a table depicting the change order (CO) requisition scenario in accordance with an embodiment of the invention.

FIG. 4 is a user interface showing list of budgets created in the spend control and budget management system in accordance with an example embodiment of the invention.

FIG. 4A, is a user interface showing creation of a budget by a user in the spend control and budget management system in accordance with an example embodiment of the invention.

FIG. 4B, is a user interface showing controller dashboard of the spend control and budget management system in accordance with an example embodiment of the invention.

FIG. 4C, is a user interface showing list of configurations in the spend control and budget management system in accordance with an example embodiment of the invention.

FIG. 5 is a transaction use case scenario of requisition PO creation with single line as event for the budget management system in accordance with an example embodiment of the invention.

FIG. 5A, is a transaction use case scenario of requisition PO creation with multiple line same budget as event for the budget management system is shown in accordance with an example embodiment of the invention.

FIG. 6 is a table with a set of data showing multiple scenario cases with data script running the codes to execute requisition task with check budget and consume budget in accordance with an example embodiment of the invention.

FIG. 6A, is a table with a set of data showing multiple scenario cases with data script running the codes to execute a partial PO task with check budget and consume budget in accordance with an example embodiment of the invention.

FIG. 6B, is a table with a set of data showing multiple scenario cases with data script running the codes to execute a PO changed, PO released and requisition task with check budget, consume budget and relates budget operation in accordance with an example embodiment of the invention.

FIG. 7 is a flowchart depicting budget consumption notification and validation of flagged data object in accordance with an example embodiment of the invention.

FIG. 8 is a flowchart depicting addition or modification of control scope or tower mapping for each of the one or more entities in accordance with an example embodiment of the invention.

FIG. 9 is a table matrix showing system components responsible for an activity or task to be executed in accordance with an example embodiment of the invention.

### DETAILED DESCRIPTION

Described herein are the various embodiments of the present invention, which includes data processing in enterprise application for real time spend control and budget management for one or more entities.

The automated data processing system allows a user to specify multiple baseline data processing criteria including matching criteria, approval criteria and data object classification criteria that define levels on matching, approval and classification for costs, quantities, accounting entities and other data attributes in data objects such as Purchase request (PR), Purchase order (PO), and invoices. The data processing system determines whether the data attributes in the data objects are exact, above or below threshold levels, the approval criteria require complex or simple approval, the data attributes such as costs are to be classified as obligated cost or committed cost. Any data object having a data attribute that is exact or below threshold level is automatically deemed approved by the system and transmitted to a data control tower for adjusting a budget data of the data control tower. Moreover, the system of the present invention provides data processing that automatically looks at additional criteria to create the most efficient automated workflow for real time readjustment of the data control tower to provide updated budgeting data to one or more entities.

The various embodiments including the example embodiments will now be described more fully with reference to the accompanying drawings, in which the various embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “purchase request,” “purchase order,” or “invoice”,” and the like, may be used herein for ease of description to describe one element or feature's relationship to another element(s) or feature(s) as illustrated in the figures. It will be understood that the spatially relative terms are intended to encompass different workflows of the process in use or operation in addition to the workflows depicted in the figures.

The subject matter of various embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, the various embodiments including the example embodiments relate to data processing for spend control and budget management for one or more entities in an organization.

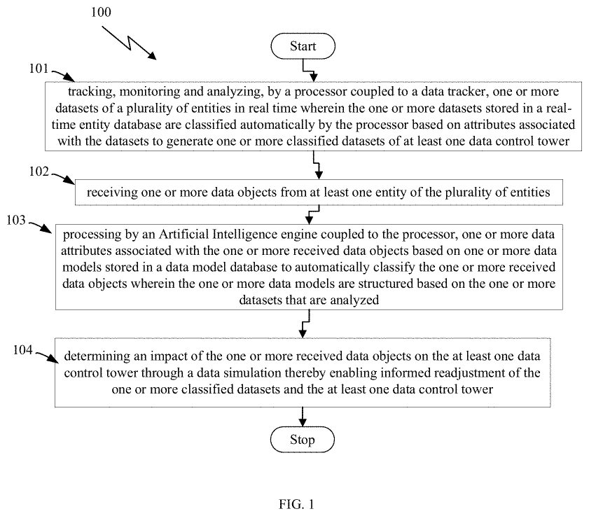

Referring to FIG. 1, a flowchart 100 depicting a data processing method for spend control and budget management is provided in accordance with an embodiment of the invention. The method includes step 101 of tracking, monitoring and analyzing, by a processor coupled to a data tracker, one or more datasets of a plurality of entities in real time wherein the one or more datasets stored in a real-time entity database are classified automatically by the processor based on attributes associated with the datasets to generate one or more classified datasets of at least one data control tower. In step 102, receiving one or more data objects from at least one entity of the plurality of entities. In step 103, processing by an Artificial Intelligence engine coupled to the processor, one or more data attributes associated with the received data objects based on one or more data models stored in a data model database to automatically classify the received data objects wherein the one or more data models are structured based on the analyzed datasets. In step 104, determining an impact of the received data object on the data control tower through a data simulation thereby enabling informed readjustment of the classified datasets and the data control tower.

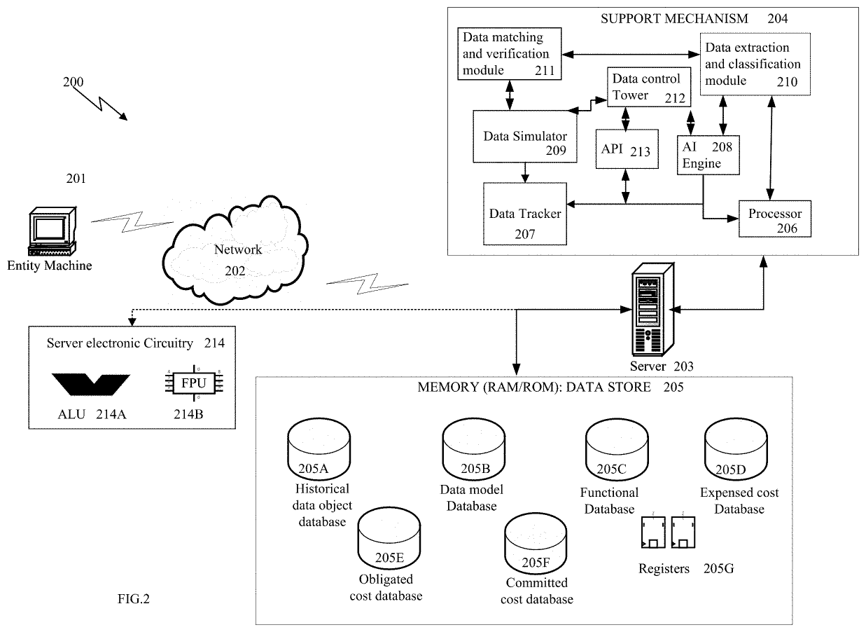

Referring to FIG. 2, a system diagram 200 of a data processing system for spend control and budget management in one or more SCM enterprise application is provided in accordance with an embodiment of the present invention. The system 200 is configured to process complex evaluations of budget consumption and availability in real time for one or more entities of an organization. It shall be apparent to a person skilled in the art that while FIG. 2 provide some components of the system, the nature of the components itself enables redesigning of the budget management architecture through addition, deletion, modification of the components and their positioning in architecture. Such addition, modification of the components depending on the nature of their function shall be within the scope of this invention.

In an embodiment, the system 200A includes an entity machine 201, a network 202, an application server 203, a budget management support architecture (BMSA) 204 and a memory or datastore 205. The BMSA 204 includes a processor 206, a data tracker 207, an AI engine 208, a data simulator 209, data extraction and classification module 210, a data matching and verification module 211, a data control tower 212, and an API 213. The data store 205 includes a historical data object database 205A, a data model database 205B, a functional database 205C, an expensed cost database 205D, an obligated cost database 205E, a committed cost database 205F and a plurality of registers 205G.

In an exemplary embodiment the data processing system is configured for real time spend control and budget management. The system includes the entity machine configured to initiate at least one task to be performed for spend control and budget management. The system further includes an application server configured to receive input from the entity machine, the application server having a budget management support architecture for spend control and budget management, depending on the type of input received from the entity machine. The support architecture includes a processor coupled to a data tracker to track, monitor and analyze, one or more datasets of a plurality of entities in real time wherein the one or more datasets stored in a real-time entity database are classified automatically by the processor based on attributes associated with the datasets to generate one or more classified datasets of at least one data control tower, an AI engine coupled to the processor configured for processing one or more data attributes associated with at least one data object received from at least one entity of the plurality of entities based on one or more data models stored in a data model database to automatically classify the one or more received data objects wherein the one or more data models are structured based on the one or more datasets after analysis; and a data simulator configured to determine an impact of the one or more received data object on the at least one data control tower thereby enabling informed readjustment of the one or more classified datasets and the at least one data control tower.

In an embodiment, the data processing system 200 includes the entity machine 201 confirmed to initiate at least one task to be performed by a budget management module/application of a SCM enterprise application. The application server 203 is configured to received input from the entity machine 201 through network 202 where the server 203 includes the budget management support architecture 204 for budget management depending on the type of input received from the entity machine 201.

Further, depending on the type of user, a GUI (Graphical user interface) of the entity machines 201 is structured by the budget management support architecture. The entity machine 201 with the GUI is configured for sending, receiving, modifying, or triggering processes and data object for executing tasks or creating certain functionalities associated with one or more of a budget management application over a network 202.

In an embodiment the entity machine 201 may communicate with the server 203 wirelessly through communication interface, which may include digital signal processing circuitry. Also, the entity machine 210 may be implemented in several different forms, for example, as a smartphone, computer, personal digital assistant, or other similar devices.

The BMSA 204 having the processor 206 coupled to the data tracker 207, tracks, monitors, and analyzes one or more datasets of a plurality of entities in real time. The entities include any accounting entity of an organization including but not limited to finance, HR, legal, procurement, any cost incurring entity whether direct cost incurring or indirect cost incurring. The datasets are stored in one or more entity database of the memory/datastore 205. The control tower 212 renders classified datasets from the one or more entity dataset where the dataset is classified automatically by the processor 206 based on attributes associated with the datasets. The classified dataset includes expensed cost dataset, obligated cost dataset and committed cost dataset. The AI engine 208 coupled to the processor 206 is configured for processing one or more data attributes associated with one or more data objects received from at least one entity of the plurality of entities at the application server 203. The one or more data attributes are processed based on one or more data models stored in a data model database to automatically classify the received data objects by the data extraction and classification module 210. The data simulator 209 is configured for determining an impact of the received data object on the data control tower 212 thereby enabling informed readjustment of the classified datasets and the data control tower 212. The data simulator 209 compares the plurality of data attributes of the received data object with a threshold data and associated threshold value to determine the impact and readjust the data control tower through a control mechanism. The control mechanism reads a key from the data object to be inserted for updating the data control tower. Next, the control mechanism computes a key cache index value from the key value contained in the data object for structuring approval flow to ensure control over any readjustment to the data control tower. The data control tower 212 is a spend data control tower providing real time budget consumption data of each of the plurality of entities.

In an advantageous aspect, the data control tower with capability to ingest data in real time, and act on it enables the user to assimilate the data, apply it on supply chain digital model and make the right decisions. This ensures that the right inventory is available at the right time, and revenue is not left on the table.

In an exemplary embodiment, the data control tower may be a hardware component or a software component or a combination of hardware and software components integrating multiple data objects through one or more applications implemented on a cloud integration platform.

In an embodiment, the software component is a bot as a computer program enabling an application to integrate with distinct data source devices and systems through a data control tower by utilizing Artificial intelligence and network connections. The hardware includes memory, processor, Controller and other associated chipsets especially dedicated for performing recalibration of data models to carry out functions for an enterprise application.

In a related aspect, the AI engine 208 transfers processed data to the GUI for visibility, exposes budget management operations through API 213 and assist the manager for spend control and budget management.

In an exemplary embodiment, the data object is a text document, an image document or a data entry through the user interface of the entity machine 201.

In another exemplary embodiment, a data attribute is extracted from the data objects by a data extraction process executed by the data extraction and classification module 210. The process includes identifying a type of the one or more data objects, sending the one or more data objects to at least one data recognition training model for identification of at least one data attribute wherein the data recognition training model processes the one or more data objects based on prediction analysis by a bot for obtaining the at least one data attribute with a confidence score, drawing a bounded box around the at least one identified data attribute by a region of interest script, cropping the at least one identified data attribute in the drawn box, extracting one or more text data from the at least one identified data attribute by optical character recognition, and validating the one or more text data after processing through an AI based data validation engine.

In an example embodiment, the data processing system includes extracting taxonomy of classification based on a plurality of unique categories from the historical data. The system utilizes Machine learning, natural language processing (NLP) and artificial intelligence techniques for processing data. Also, in this non-limiting example embodiment, classification code vectors are obtained from training data corresponding to each of the categories of classification. This method further includes performing feature extraction to obtain distinct words from the data object or spend data as variables. The data is transformed into a training data matrix of variables with historical data object. The training classification model is created from the classification code vectors and the training data matrix by using the machine learning engine (MLE) and the AI engine. To obtain a training classification model from the historical data of the identified entity, reading the data matrix X and the classification code vector ‘y’ and the input matrix as [X y]. Further, a Naïve Bayes (NB) training model is obtained by applying a Naïve Bayes algorithm, a Support Vector machine (SVM) training model is obtained by applying support vector algorithm and a Logistic regression training model is obtained by applying Logistic vector algorithm (LR). These models are saved on computer program product to be used in classification of data object or spend data related to one or more entity or data attributes associated with data objects.

The system 200 of the present invention is configured to execute a check budget instruction for determining the impact of the received data. The instruction is configured to cause the processor 206 to match one or more entities in the data object for identifying a virtual entity, match the data attributes of the data object for verification of the virtual entity by the data matching and verification module 211, match extent of budget consumption in data control tower 212 by checking for partial PO execution, checking for available funds from entity other than the identified virtual entity to capture actual real time budget consumption data and issue approval or rejection through the API 213.

The computing devices referred to as the entity machine, server, processor etc. of the present invention are intended to represent various forms of digital computers, such as laptops, desktops, workstations, personal digital assistants, and other appropriate computers. Computing device of the present invention further intend to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this disclosure.

The system includes the server 203 configured to receive data and instructions from the entity machines 201. The system 200 includes the budget management support mechanism 204 for performing various processes with multiple functions including historical dataset extraction, classification of historical datasets, artificial intelligence-based processing of new datasets and structuring of data attributes for analysis of data, creation of one or more data models configured to process different parameters, structuring of workflows for execution of budget approvals or rejections etc.

In an exemplary embodiment, the system 200 is provided in a cloud or cloud-based computing environment. The system 200 is implemented on a codeless development platform architecture that enables more secured processes and easy additions or removal of workflows to execute the tasks.

In an embodiment the server 203 of the invention may include various sub-servers for communicating and processing data across the network. The sub-servers include but are not limited to content management server, application server, directory server, database server, mobile information server and real-time communication server.

In example embodiment the server 203 shall include electronic circuitry 214 for enabling execution of various steps by processor. The electronic circuitry 214 has various elements including but not limited to a plurality of arithmetic logic units (ALU) 214A and floating-point Units (FPU's) 214B. The ALU 214A enables processing of binary integers to assist in formation of at least one table of data attributes where the data models implemented for dataset characteristic prediction are applied to the data table for obtaining prediction data and recommending action for codeless development of SCM applications. In an example embodiment the server electronic circuitry includes at least one Athematic logic unit (ALU) 214A, floating point units (FPU) 214B, other processors, memory, storage devices, high-speed interfaces connected through buses for connecting to memory and high-speed expansion ports, and a low-speed interface connecting to low-speed bus and storage device. Each of the components of the electronic circuitry, are interconnected using various busses, and may be mounted on a common motherboard or in other manners as appropriate. The processor can process instructions for execution within the server 203, including instructions stored in the memory or on the storage devices to display graphical information for a graphical user interface (GUI) on an external input/output device, such as display coupled to high-speed interface. In other implementations, multiple processors and/or multiple busses may be used, as appropriate, along with multiple memories and types of memory. Also, multiple servers may be connected, with each server providing portions of the necessary operations (e.g., as a server bank, a group of blade servers, or a multi-processor system).

In an embodiment, the processor 206 generates a controller dashboard within the GUI enabling a user to run the data simulation on a requested PR data object to assess impact of the PR data object on a budget in case the PR data object is approved or rejected thereby enabling informed execution of the PR data object. The system includes a control mechanism to process purchase request (PR) data object based on the threshold value set for each entity. Further, a network communication transmits the PR data object determined to be approved for generating a PO to a remote system.

In an exemplary embodiment, the GUI enables cognitive computing to improve interaction between user and a budget management application(s) in supply chain system applications. The interface improves the ability of a user to use the computer machine itself. Since, the interface triggers support architecture to execute one or more tasks including but not limited to processing of Purchase request, Purchase order, invoice etc., at the same instant, the interface thereby enables a user to take informed decision based on real time budget information. By structuring operations and application functions through a budget management support architecture and eliminating multiple cross function of checking with multiple entities for estimating actual available budgets, repetitive processing tasks and recordation of information to get a desired data or operational functionality, which would be slow and complex the user interface is more user friendly and improves the functioning of the existing computer systems.

The processor 206 may be implemented as a chipset of chips that include separate and multiple analog and digital processors. The processor may provide coordination of the other components, such as controlling user interfaces, applications run by devices, and wireless communication by devices. The Processor 206 fetches instructions, interprets instructions, fetches data, executes instructions, write data results to memory or I/O module through its structural components including ALU, Control Unit, Registers, internal cache etc. As part of the fetch operation, the processor utilizes the address bus for fetching the instructions and the control unit requests memory read operation. The control unit further interpret instructions by examining the contents of the data object, determines the addressing mode of an operand specifier, e.g., indirect and then executes the indirect cycle. The Processor 206 may communicate with a user through control interface and display interface coupled to a display. The display may be, for example, a TFT LCD (Thin-Film-Transistor Liquid Crystal Display) or an OLED (Organic Light Emitting Diode) display, or other appropriate display technology. The display interface may comprise appropriate circuitry for driving the display to present graphical and other information to an entity/user. The control interface may receive commands from a user and convert them for submission to the processor. In addition, an external interface may be provided in communication with processor, so as to enable near area communication of device with other devices. External interface may provide, for example, for wired communication in some implementations, or for wireless communication in other implementations, and multiple interfaces may also be used.

In an example embodiment, the system 200 of the present invention includes a front-end web server communicatively coupled to at least one database server, where the front-end web server is configured to process the dataset and data attributes associated with data objects based on one or more prediction data models and applying an AI based dynamic processing logic to automate budget management actions through support architecture 204 for structuring the approval or rejection workflow.

In an exemplary embodiment, the present invention provides one or more spend control and budget management Supply chain enterprise application with an end user application UI and a citizen developer user application UI for structuring the interface to carry out the required operations based on the codeless platform.

In an example embodiment, the data store 205 or memory device stores all data attributes of a document as a single record, much like a relational database system. The data is usually denormalized in these stores, making data joins common in traditional relational systems unnecessary. The data store 205 includes a historical data object database 205A configured for storing historical data from PR/PO and invoice for one or more entities. The entities have a real time entity database that feeds the real time information to the historical database 205A for processing by the processor 206. The data store 205 includes a data model database 205B configured for storing one or more data models for processing one or more data attributes associated with the data objects. The data store 205 also includes a functional database 205C configured for storing a library of functions configured to generate a plurality of fixtures for processing data objects received at the server 203. The server 203 with a controller encoded with instructions enables the controller to function as a bot for generating the fixtures to process the data objects. The plurality of fixtures are backend scripts by the bot based on a SCM scenario data, received data objects and AI based processing for enabling automation of a data processing operation. The SCM scenario data includes but it not limited to modification to one or more data attributes of the data objects such as cancellation of item, modification of cost, change in entity or duration etc. The AI based processing includes a processing logic that integrates deep learning, predictive analysis, information extraction, planning, scheduling, optimization, and robotics for processing the data objects.

The data store 205 includes an expensed cost database 205D for storing expensed cost dataset that includes costs related to goods or services already received or consumed by the one or more entities. Further, the data store includes obligated cost database 205E and committed cost database 205F. The obligated cost database 205E stores dataset that includes costs to be incurred to the one or more entities based on issued Purchase orders (PO). The committed cost database 205F stores dataset that includes costs predicted to be incurred to the one or more entities based on generated purchase request (PR).

The data source for the spend control and budget management system includes costs for materials and services whether Direct or Indirect cost (IC) Control scope (Cost Element and GL out of scope), Spend Control Tower Mapping (Cost element and GL mapping), Budget Definitions, Budget Approvals flows and control thresholds, Direct Budget Updates (of Actuals and Open PO) and PR data (automatically updated on PR submit).

The memory data store/data lake 205 of the system may be a volatile, a non-volatile memory or memory may also be another form of computer-readable medium, such as a magnetic or optical disk. The memory store 205 may also include storage device capable of providing mass storage. In one implementation, the storage device may be or contain a computer-readable medium, such as a floppy disk device, a hard disk device, an optical disk device, or a tape device, a flash memory or other similar solid-state memory device, or an array of devices, including devices in a storage area network or other configurations.

In an embodiment the system of the present invention built on the codeless platform architecture where the architecture enables creation and management of smart templates, framework to define GUI screens, controls etc. through use of templates. Seamless support is built to enable specific instances (created at runtime) to have personalized themes, extensive customization of the user experience (UX) for each client entity and or document.

In an embodiment, the system with codeless platform provides a set of microservices to support creation of documents (requisition, order, invoice, etc.), support the interaction of the documents with other documents (ex: invoice matching, budget amortization, etc.) and provide differentiated operational/functional value for the documents in comparison to a competition by using artificial intelligence and machine learning. The system also enables execution of complex operational/functional use cases involving the data objects or documents.

In one embodiment, the one or more data objects includes a purchase request (PR) data object, a Purchase Order (PO) data object, an invoice data object, or any SCM scenario data requiring readjustment of the budget consumption data related to the one or more entities in the data control tower. The one or more data object comprises a plurality of data attributes including cost, item details including quantity of item, supplier name, duration, and terms.

In another embodiment, the one or more data objects includes application functional data objects such as Taxonomy associated to a document, sub class of the document (contract type, PO type, Invoice type, business unit, line of business, ship and bill to location, item category, stakeholder types) document Types, Application Types, Supplier location, Region of business, taxation attributes, Line attributes, clause type, approval type, and document value (invoice amount, contract amount), a data range/duration, accounting entity and cost.

It shall be apparent to a person skilled in the art, that the data objects listed in the application are examples relating to data objects for spend control and budget management in Supply chain application. The list provided is not exhaustive and may include other data objects that are within the scope of the current disclosure related to supply chain application.

In an embodiment, the system 200 of the present invention provides a historical approval or rejection workflow knowledge database configured for storing historical workflow dataset wherein the workflow of the budget management operation is structured based on the historical workflow dataset by building model-driven flows incorporating application process within budget management of supply chain.

In an exemplary embodiment, the system includes a blockchain connector for integrating blockchain services with one or more budget management application and interaction with one or entity platforms. The blockchain network enables connection to the plurality of entities working from their respective entity machines and connected through a secured blockchain network to an application server for executing budget management functions.

In an embodiment, the present invention uses GPUs (Graphical processing units) for enabling AI engine to provide computing power to processes humongous amount of data.

In an exemplary embodiment, the AI engine employs machine learning techniques that learn patterns and generate insights from the budgeting data/data objects for enabling the processor 206 to automate operations. Further, the AI engine 208 with ML employs deep learning that utilizes artificial neural networks to mimic neural network. The artificial neural networks analyze data to determine associations and provide meaning to unidentified or new dataset.

In another embodiment, the invention enables integration of Application Programming Interfaces (APIs) for plugging aspects of AI into the dataset characteristic prediction and operations execution for processing of data objects with the spend control and budget management system. The API is a rest end point exposed so that it can be integrated with any application very easily. The web API as a component automates all the process related to budgeting aspect of the system which helps in spending control.

The system of the invention provides budget management workflow visualization through Model driven AI pattern. The processor 206 is responsible to generate operational process workflow like business process through AI using model driven pattern. The models are generated using combination of historical workflow and details from experts. Modeling decision of existing business process are driven manually by Subject Matter Expert. Combining Functional Industry Knowledge and its structure into rules decision are better approached by using Industry Knowledge and Machine Learning (making use of Historical knowledge Data). The ML makes data processing based on the historical workflow data as ML brings knowledge of operational/business process and interpretation.

Further, data driven model relies on larger volume of data. The data driven AI pattern is driven by historical knowledge data while deterministic are driven through expert and deep learner's engine focused on specific problem areas. The data driven AI patterns relies on smaller data sets which are accurate as they are focused on budget management workflows and targeted for various industry verticals. The combination of subject matter expert small data for AI and big data for AI accelerates the model-driven AI workflow pattern. In the present invention a combination of subject matter expert and machine-driven training is applied simultaneously to feed small data expertise into machines. The intelligent model driven AI leverages small data to enhance operational process for spend control and budget management.

In a related embodiment, the model-driven AI flow enables users to access data in a unified manner regardless of the underlying data store. Data store queries (E.g., relational, or file systems) are significantly streamlined for structuring the workflow. The essential aspects of time and space, data normalizing, versioning, and tracking are all handled by the system thereby enabling the user to work on functional performance.

The AI engine 208 enables monitoring of workflow across the spend control and budget management applications. The engine 208 with the processor 206 enables the support architecture 204 to create multiple approval workflows.

In an embodiment, the AI engine 208 coupled to the processor 206 takes a record centric view of all transactions applied to different records for the approval process. For example, an invoice record goes through different verification stages compared to a requisition for approval. Even within those types, there may be subtypes which require different business rules to act on them.

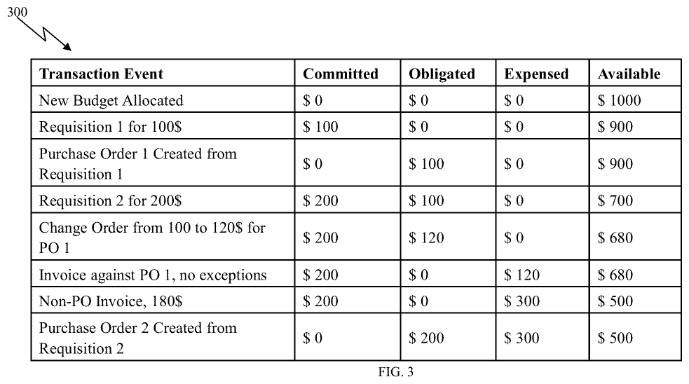

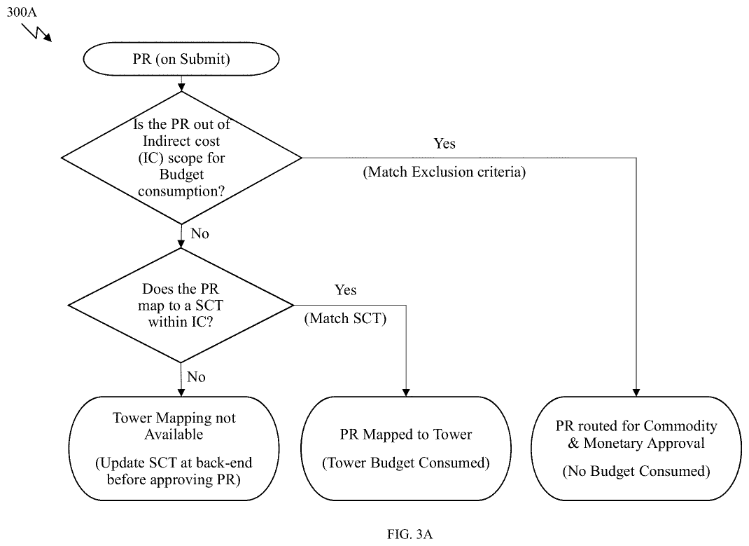

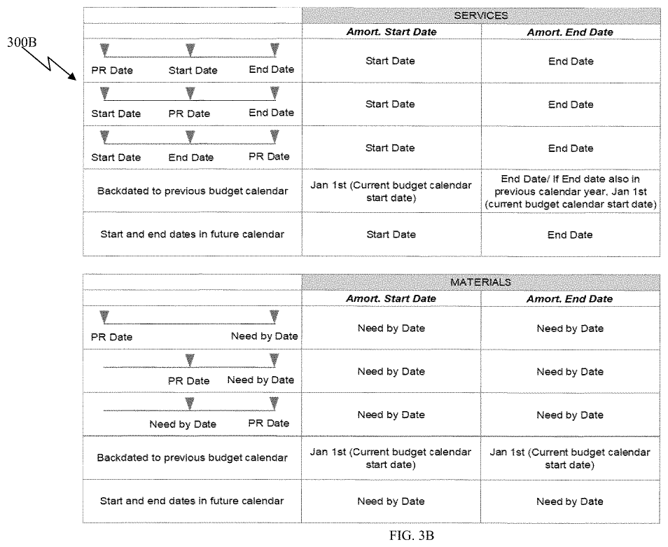

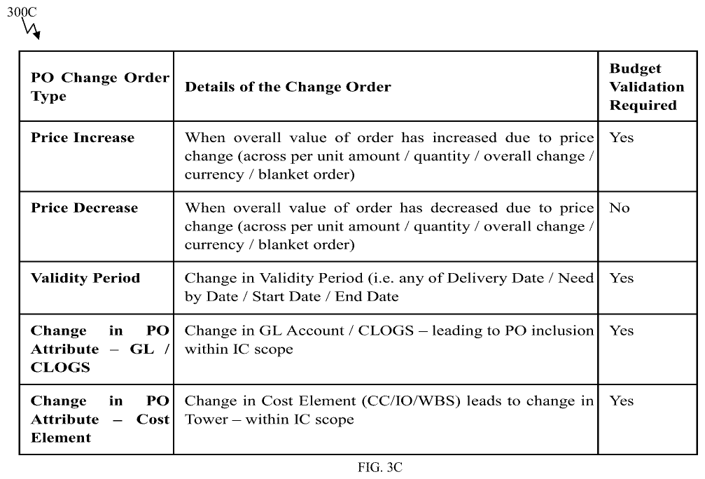

Referring to FIG. 3, a table 300 depicting budget fund movement between expensed, obligated and committed database as transactions are created in the system is shown in accordance with an embodiment of the invention. When the requisition is submitted, budget is consumed from the Spend control tower (Virtual Entity) of the cost element. As a transaction moves through the Procure to pay process, the system tracks the consumption based on the transactions in separate buckets as expensed funds/costs, obligated funds/costs and committed fund/costs.

The Expensed costs are those which has been consumed by the organization and therefore payments will have to or is already made to the suppliers. Expensed costs result when supplier invoice is acknowledged following goods receipt i.e an invoice or accrual is an expensed cost. In the absence of timely invoicing by the supplier, expense cost is that which is incurred as per the accounting accrual principle. E.g., If goods worth $1,000 is used in producing an end product by the organization, even if the invoice of $1,000 is not sent by the supplier, the organization should accrue expense of $1,000 on account of having consumed the goods. The source of the Expense cost can be monthly report published by the finance and accounting department of the organization or the invoice report for the concerned period from the Enterprise Resource Planning (ERP) System.

The Obligated costs are those which can be incurred by the organization in the future because of calling off goods and services from POs which are valid and have balance values left in them. E.g., If a PO worth €5,000 for a service was issued to a supplier, and the PO had a start date of 1^{st} of May and end date of 30th of September. The current date is 10^{th} of August and €3,000 has been invoiced by the supplier as of 30^{th} of June. The balance €2,000 left in the PO is assumed to be incurred in the future at a rate of €1,000 for each of the remaining months of the PO, i.e €1,000 for August and €1,000 for September.

The Committed costs are those which can become a commitment for the organization to spend because of a PR being generated which is yet to be converted into a PO and issued to the concerned supplier. Because of PO not being issued there is no legal obligation to incur the cost. The organization can cancel the PR and minimize its cost commitments.

In an example embodiment, the budget consumption is determined as Budget Consumption %=((Expensed cost+Obligated cost+Committed cost)/(Budget))×100. As a Purchase request flows through the procure to pay process, it will consume funds from the available bucket and record consumption against the appropriate bucket. The consumption can be tracked for each of the accounting related entity for each of the period. Accounting related entity and period can be setup based on the organization requirement. As a result of the budget management system, every time a PR is raised, the system can process the attributes to evaluate the revised budget consumption. The attributes include start date or end date or need by date, accounting entity like cost center, business unit etc. Based on the budget consumption data, conditional approval process is triggered to ensure the consumption is tracked and controlled. For E.g., If budget consumption is above 90% and below 100%, route the PR to finance head of the concerned accounting entity for budgetary approval or If budget consumption is above 100%, block the PR from being processed further until additional budgets have been made available.

Referring to FIG. 3A, a flow diagram 300A depicting budget consumption of Purchase requisition is shown in accordance with an embodiment of the invention. The system auto-triggers the PR submitted by the entity machines and identifies if PR cost element is in Indirect cost scope and maps to the corresponding data control tower budget consumption. It shall be apparent to a person skilled in the art that the cost scope can be any cost whether direct or indirect. For the purpose of explanation, FIG. 3A shows the flow diagram considering Indirect cost (IC) as an example embodiment. Based on IC Scope set-up, the system checks if cost element of a PR is within scope of budget consumption or to be excluded. For the PRs in scope, based on the Spend Control Tower set-up, the PR will be mapped to the corresponding Spend Control Tower. One PR line item will only be mapped to one Spend Control Tower. In case, one PR line matches to multiple Spend Control Tower, then tool will map PR line to spend control tower with higher priority as defined by the rules. The PRs with tower mapping not available will be sent to a predefined approver. Any PR rejection/withdrawal/PO cancellation will release funds back to Control tower and is made available for consumption.

Referring to FIG. 3B, a table depicting budget consumption with PR for services and materials is provided in accordance with an embodiment of the invention. After mapping of PR to SCT (spend control tower), PR will be amortized across the validity period and consume budget from that SCT for the corresponding period.

In an example embodiment, the PR Amortization rules include a) Fixed (Limit) POs/PRs are amortized equally in days from the Start date to the End date of the PO/PR. b) Materials (Standard) PO/PRs are fully amortized in the period of need-by date of the PO/PRs c) Material PO/PRs with OUM “MON” & “YR” are amortized in the month they apply to, calculating back from the need by date to the first period applicable d) POs/PRs backdated to previous calendar year are amortized from the start of the budget calendar (1st January of current year). Further, the obligations are updated based on rules including, (i) Fixed (Limit) POs will be amortized as per split provided b/w Start & End Date and, (ii) Material (Standard) POs will be fully amortized based on the accrual in the offline Open PO file.

In an exemplary embodiment, the system of the present invention is configured to process change order (CO) requisitions as data objects. Referring to FIG. 3C, a table 300C depicting the change order (CO) scenario is shown. The Change orders refer to requests to change details of existing PO. It is triggered by clicking on ‘External Change Order’ field in an existing PO. Whenever change order is triggered, the system reviews the changes to cost, date and accounting related entity. If any of these three fields are modified, then the system automatically adjusts the Obligated cost to reflect the change. For E.g., assume an existing PO with details as Cost Centre ABC, Cost €4000, Start Date 1st October, and End Date 30th November, is changed to Cost Centre XYZ, Cost €8000, Start Date 1st November, and End Date 30th November, and the change order is triggered on 1st September, then because of the change order being approved, the obligated spend of Cost Centre ABC for October is reduced by €2000, and similarly for November is reduced by €2000. Further, the Obligated spend of Cost Centre XYZ is increased by €8000 for November. In short, whenever a Change Order (CO) is placed, the existing budget consumption of parent Purchase Order (PO) is released, and relevant budget is consumed as per CO details (CO type, cost entity, GL account, Material/Service, applicable dates, amount). If PO corresponding to the Change Order has already been expensed, (Changed PO value—Expensed) amortized from Start date to End date. Based on budget consumed, approval flows will be triggered as per Control thresholds and approval Flow set-up, and this is applicable across all kinds of Change Orders to be received by the system application.

In an advantageous aspect, the invoice/accruals/open-PO/non-PO data is visible on budget management system at a quarterly level. The actuals/open-PO/non-PO are updated dynamically and the system provides the provision to update these numbers automatically with an xml or excel file as Direct Budget Update. The details are loaded at a PO transaction level. The steps to update actuals/open-PO/non-PO for Budget Consumption of Spend Control Towers/data control tower include a) Details on actuals, accruals, Non-PO to be tabulated in the template at a PO line-item level (as applicable); b) The system provides the ability to update Invoice/Accruals (expensed spend), Open-PO, Non-PO provisions (obligated) via an excel upload on a PO-transaction level; c) In this scenario, no control actions will be triggered; d) All changes to the Controller Dashboard are dynamic; e) the reports are rendered on the GUI.

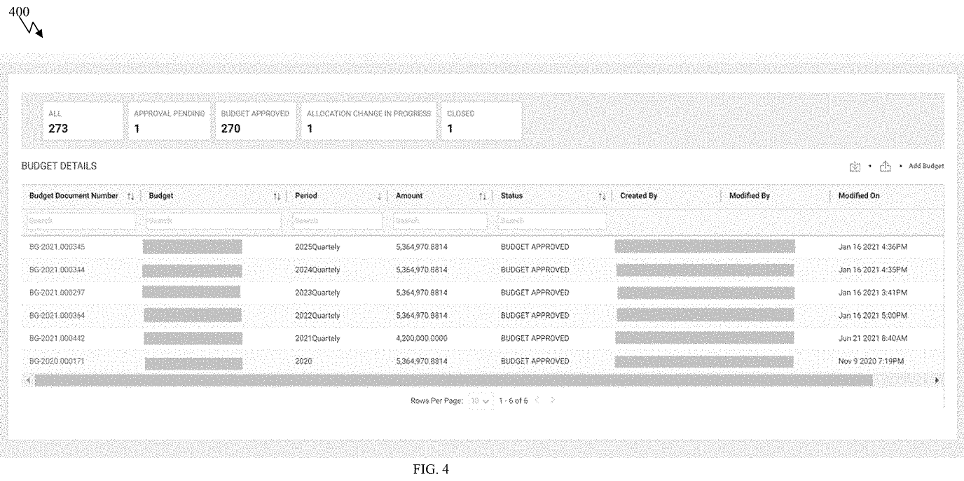

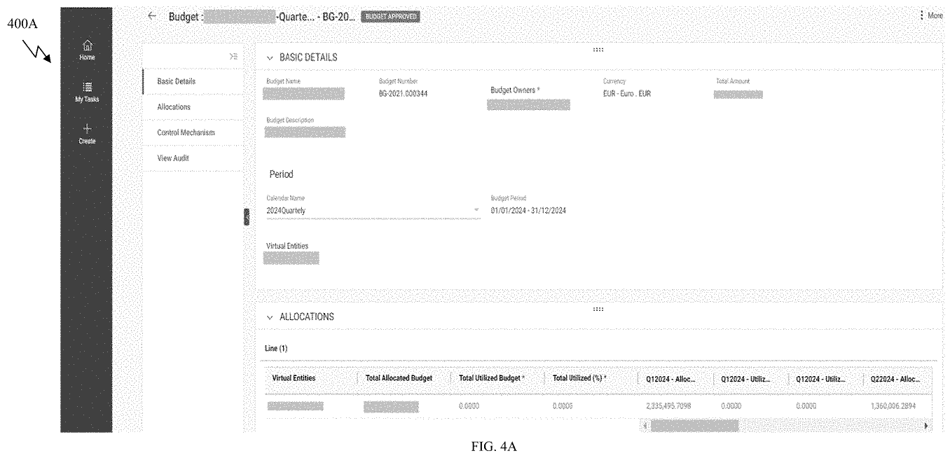

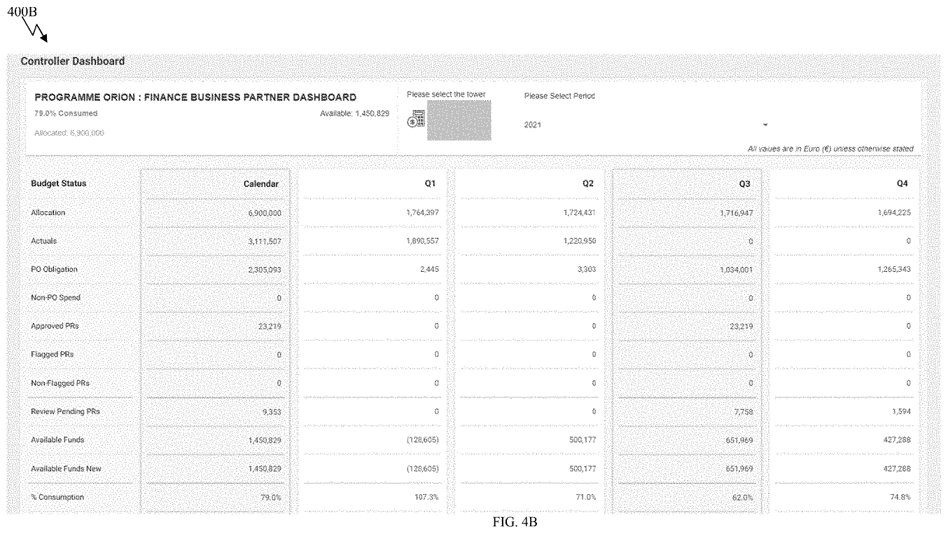

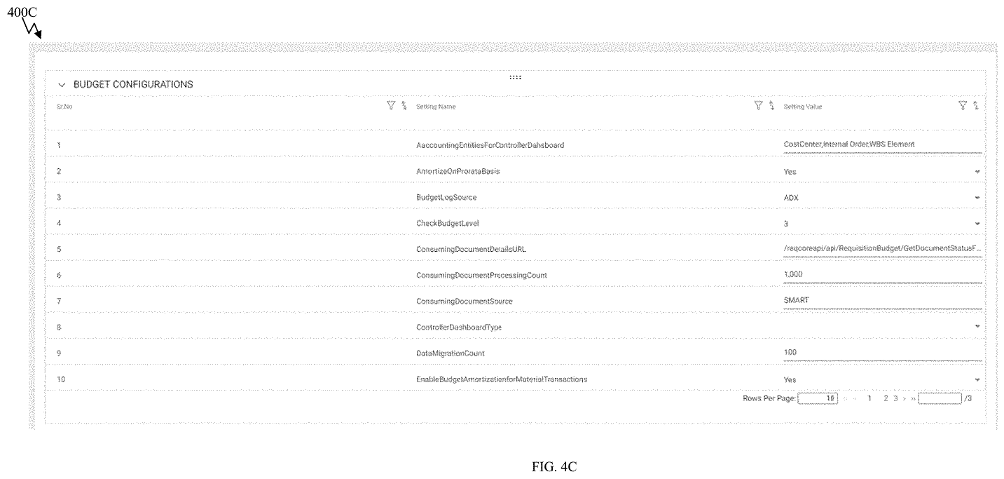

Referring to FIG. 4, a GUI 400 showing list of budgets created in the spend control and budget management system in accordance with an example embodiment of the invention. The GUI renders information such as budget name, period, document number, amount, status etc.

Referring to FIG. 4A, a GUI 400A showing creation of a budget by a user in the system in accordance with an example embodiment of the invention. The GUI 400A renders tabs/labels/objects for entering budget name, number, currency, period etc. It shall be apparent to a person skilled in the art that one or more information may be entered automatically by the system, or manually by user or through voice commands.

Referring to FIG. 4B, a GUI 400B showing controller dashboard of a budget management system in accordance with an example embodiment of the invention. The GUI 400B renders information including but not limited to budget status such as Allocation (current year ambition), Actual (invoiced and accrued), PO obligation (Open PO and approved PO), non-PO spend (Corrections and Non-PO estimate), Approved PRs (Spend from PR in approved state but not yet accepted by ERP), Flagged PRs (Submitted PRs flagged for budget validation), Non-flagged PRs (submitted PRs not flagged), Review pending PRs, Available funds (allocation−(actual+PO obligation+flagged PRs+Non-flagged PRs)), Available funds New, % Consumption (1−(available funds/Allocation)), and % Consumption New (Basic scenario change in table and PRs flagged for approval). Further, the GUI 400B renders quarterly (Q1, Q2, Q3, Q4) spread budget numbers, approval scenario analysis etc. The dashboard provides real-time visibility of the budget consumed by actuals, commitments, Open-PO, and Non-PO at the level of data control tower. Also, it provides tabulated information on PRs flagged for Budget Validation. Within the table, the entity can execute through a PR id an approve/reject of a PR document.

Referring to FIG. 4C, a GUI 400C showing list of configurations in the budget management system in accordance with an example embodiment of the invention. The GUI 400C, renders information including accounting entities for controller dashboard, amortize on pro rata basis, budget log, check budget etc.

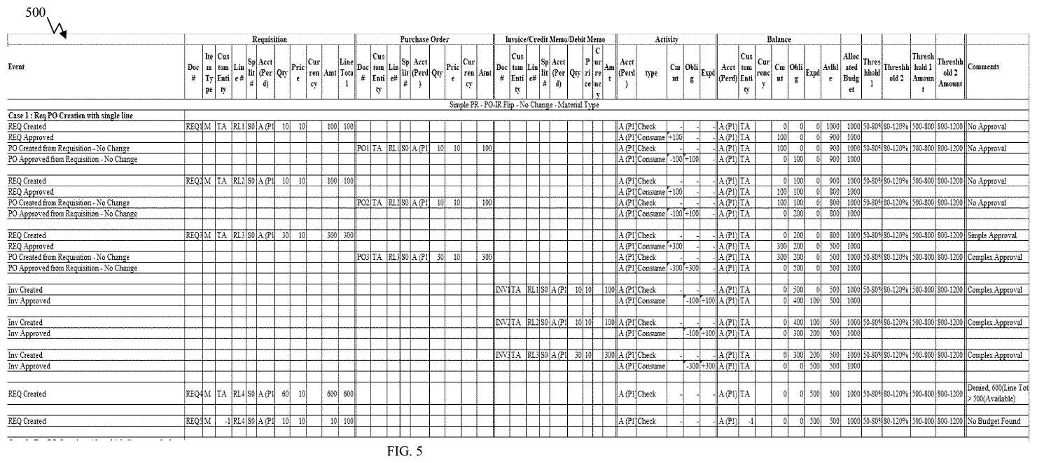

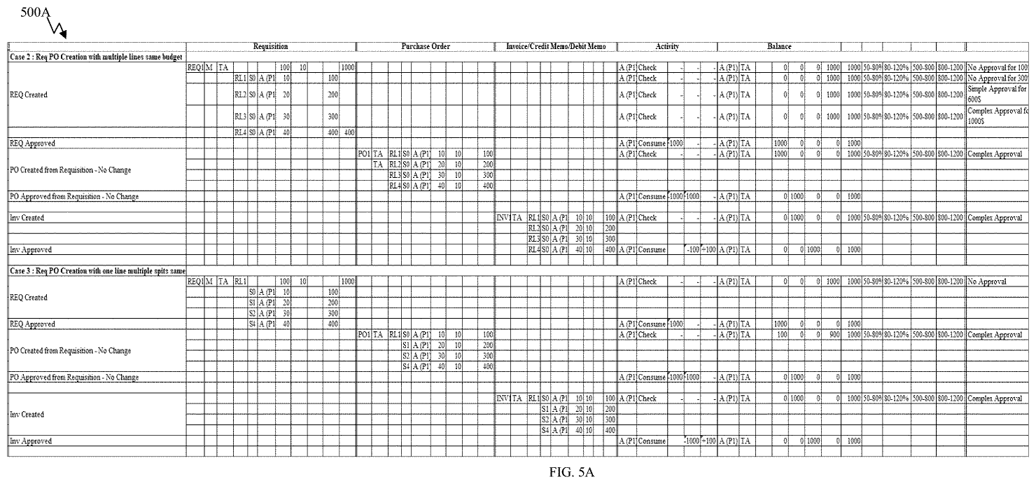

Referring to FIG. 5, a transaction use case scenario 500 for the budget management system is shown in accordance with an example embodiment of the invention. The scenario provides a case for requisition PO creation with single line as an event. The multiple data objects including PO, PR and invoice creation with approval or rejection are shown.

Referring to FIG. 5A, a transaction use case scenario 500A for the budget management system is shown in accordance with an example embodiment of the invention. The scenario provides a case for requisition PO creation with multiple line same budget as event and for requisition PO creation with one-line multiple splits as an event. The multiple data objects including PO, PR and invoice creation with approval or rejection are shown.

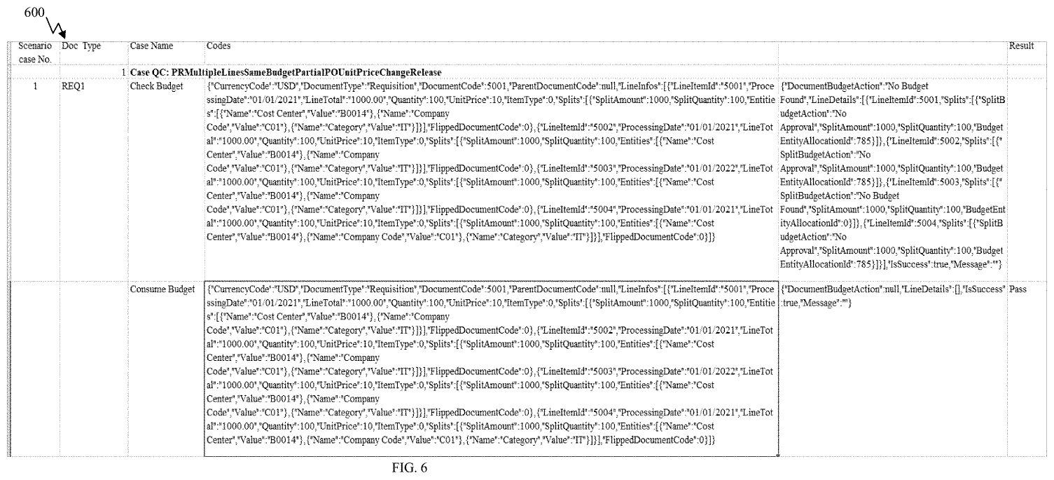

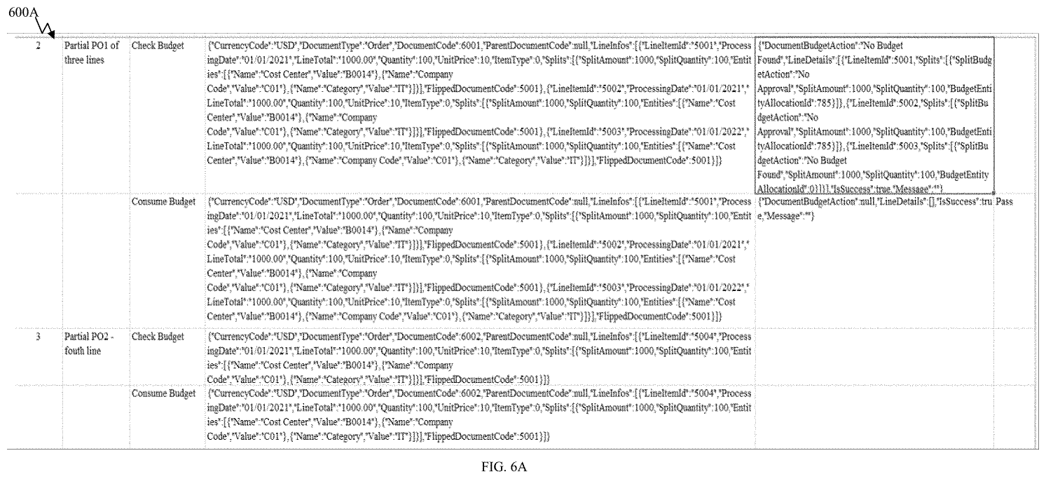

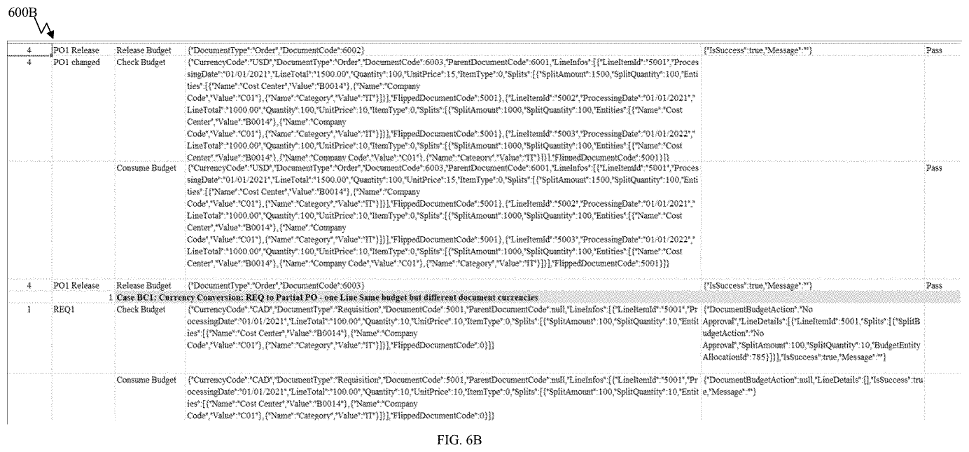

Referring to FIG. 6, a table 600 with a set of data showing multiple scenario cases with data script running the codes to execute a task is shown in accordance with an example embodiment of the invention. The table 600 shows check budget and consume budget operation with codes for executing the task for a document type requisition.

Referring to FIG. 6A, a tablet 600A with a set of data showing multiple scenario cases with data script running the codes to execute a task is shown in accordance with an example embodiment of the invention. The table 600A shows a check budget and consume budget operation with codes for executing the task for a document type partial PO.

Referring to FIG. 6B, a table 600B with a set of data showing multiple scenario cases with data script running the codes to execute a task is shown in accordance with an example embodiment of the invention. The table 600B shows a check budget, consume budget and release budget operation with codes for executing the task for a document type PO changed, PO released and requisition.

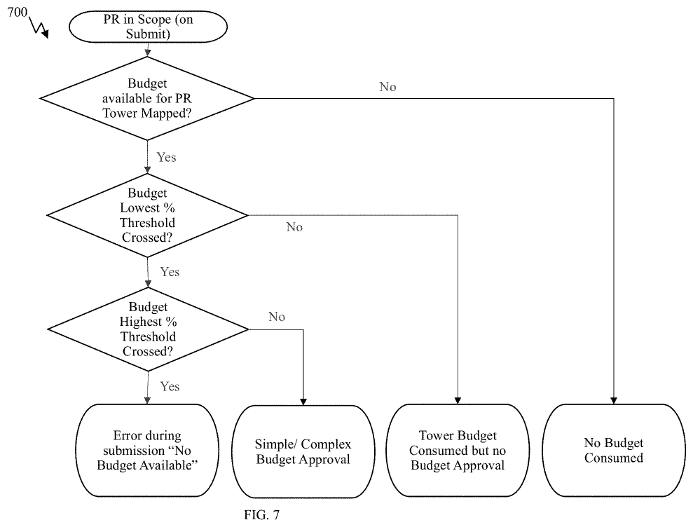

Referring to FIG. 7, a flowchart 700 depicting budget consumption notification and validation of flagged data object is shown in accordance with an example embodiment of the invention. Anytime a threshold is crossed a notification is sent to the entity user (budget owner/budget administrator). When a budget crosses 100% utilization or maximum threshold, a notification is sent to the budget owner(s) for that budget and budget administrator. Additionally, whenever a document goes through budget-related approvals due to control thresholds being crossed the approver(s) will get approval notifications to approve the documents. Both Simple and complex approval thresholds are specified. If the PRs are blocked due to Error “No budget Available”, ambition can be reallocated across quarters or additional ambition can be requested.

In a related embodiment, a budget allocation is updated dynamically based on the data object received at the server. For a change in allocation across quarters with no change in annual budget the system auto approves the PO. For a change in threshold the default levels may be set automatically depending on the actual budget availability. Alternatively, the entity may adjust the threshold levels depending on the organizational priority and requirements. Further, changes to the complex approval flow may also be made dynamically through the data script depending on the impact of the received data object.

In an exemplary embodiment, the system of the present invention includes a plurality of data control tower with one each for each of the one or more entities of an organization. The data control towers define the list of Spend Control Towers (referred to as ‘Virtual entities’ in technology parlance) to which PRs will be tagged for budget consumption. The system is configured to set-up Spend Control Towers based on accounting entities (Plant, Account Type, Item category, Accounting Assignment, Cost center, Internal Order (IO), WBS (Work breakdown structure) element, GL), Organizational entities (Company code, purchasing org., purchase Group) and Categories (classification of goods and services—CLOGS). A budget Administrator is responsible for sign-off on Spend Control Tower set-up on the system. The system works on the assumption that one Cost element will be uniquely mapped to one spend control tower (SCT).

In an example embodiment, each Spend Control Tower requires a Budget Definition for which budget consumption is calculated and monitored. Budget Definition requires setting up following elements including type of user (Budget Owner, Budget Administrator), Budget Calendar, Budget period, Virtual entity, Budget allocation, Budget controls and approval workflows, and Budget Hierarchy. Depending on the type of user the GUI restructures itself for supporting functions. In case the user is a budget owner, the user is a Guardian of the Spend Control Tower budgets, approves PRs mapped to corresponding SCT, raises requests for budget increase/re-allocation to Budget Administrator. The system enables set up of multiple Budget Owners for a SCT. In case the user is a budget administrator, the user is an owner for all information in budget manager, has access to all budget definitions, approves requests for budget increase/re-allocation and responsible for master data set up within the Budget Manager. The budget calendar element defines the complete date range for which budget is tracked, budget can have only one calendar and it cannot be changed once budget is published and consumption begins. The budget period falls within the calendar time-period. Budget for the whole calendar is the total for the budget allocations for each period. The virtual entity includes spend Control Tower name for budget consumption and it is to be selected from drop-down on in GUI interface. Budgets are set at Spend Control Tower (Virtual Entity) level with a quarterly split. Control measures are activated at thresholds (%) of budget consumption for a SCT. The approval includes simple and complex approval process. Further, the system allows flexibility to set-up hierarchy at multiple levels. The system also provides budget consumption at these hierarchies, sets up owners and facilitates approval process.

In an example embodiment, the budget Controls and approvals are set up for each Spend Control Tower to monitor and validate incoming requisitions for Budget Validation. The system triggers budget validation process if the budget consumption for a tower breaches the threshold limits. More than one threshold ranges and corresponding approval flows (Simple/complex) may be set up. If the budget utilized is within the defined threshold ranges, the system can trigger either simple approval or complex approval. In case of Simple approval (Default) requisition is directed to the budget owner for approval. In case of Complex approval (Customized) requisition is directed based on custom rules on specified for SCT. Further, monetary limits can be set up for requisition routing to different approvers. For example, if threshold range is set from 60% to 100% for Complex Approval and 100.1% to 150% for Simple Approval, then at 70% budget consumption, PR will be routed for Complex approval as per custom rules; at 120% budget consumption, PR will be routed to Budget owner for validation and at 160% budget consumption, the system will stop all submission of PRs for the budget until changes are made. The system also allows Hierarchy approval, which will route the document to the budget owner and other approvers defined in the hierarchy for consumption threshold breached (Not enabled). The PRs are routed for Budget validation if requisition hits consumption threshold at period and/or calendar level.

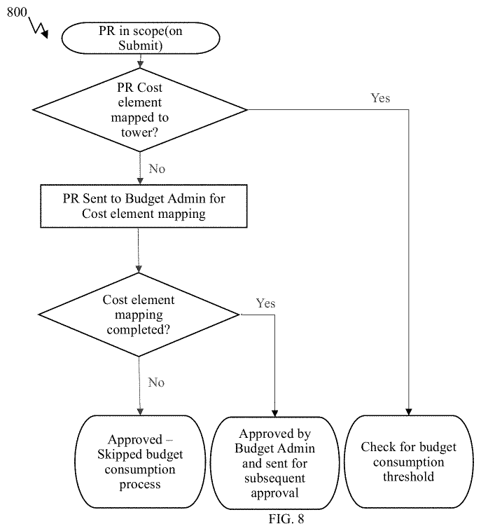

Referring to FIG. 8, a flowchart 800 depicting addition or modification of control scope or tower mapping for each of the one or more entities is provided as an example. For addition of control scope or tower mapping, new costs elements are mapped to existing towers by sending a request to the system. The updated mapping is performed when a PR is submitted with a new cost element. If the cost element is not excluded for the control scope and tower mapping for the corresponding cost element is unavailable, then system routes such PR with values to an approver. The approver may be an auto approval system with processing of conditions set as recommended or alternate (for time sensitivity PRs). In recommended execution, the system updates spend control setup by sending an update request to the system. The approval of PR/PO is done on confirmation of updated mapping and the requisition hits budget of the corresponding data control tower. In alternate execution, the system approves requisition and updates the tower mapping in parallel. However, in alternate execution the requisition will not hit any budget and will not be reflected in budget consumption. For modification of control scope or tower mapping, the cost elements mapping to existing control towers can be changed. The changes are effective for forthcoming requisitions (i.e requisitions that are yet to be submitted). The current or past requisition will not be impact by such modification.

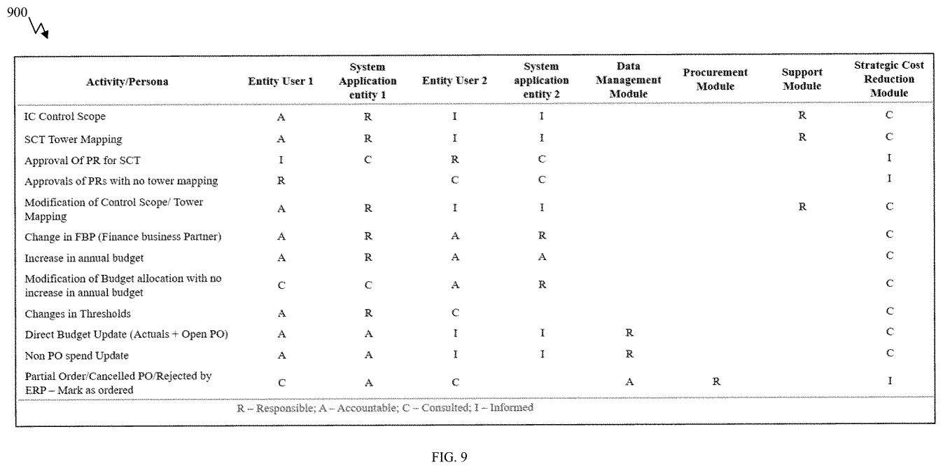

Referring to FIG. 9, a table matrix 900 showing system components responsible for an activity or task to be executed is provided in accordance with an example embodiment of the invention. The matrix identifies the responsible, accountable, consulted and informed entity and system modules for execution of tasks. The entity may be a user, or an automated component of the system configured to execute the tasks.

The AI engine of the system further determines tradeoff between tasks that require user approval vs. automated approval to enable automation of process flows. The implementation of the flow includes augmenting the Bayesian model obtained in previous step with additional metadata from the transaction, using the posterior probabilities of each task against the approval of the transactions to determine the importance likelihood of the specific task and for tasks with high importance, the system can automate the approval based on budget availability. Moreover, the system automates transfer of budget from one entity to another depending on the importance of the PR or PO data object to be executed. Further the attributes can be configured for each task.

In an exemplary embodiment, the AI engine also executes anomaly detection and approval level optimization. The Anomaly Detection identifies one-off flows or issues/blockages that may arise with automation of various steps, viz. failure modes. In large organizations, this is also helpful to identify situations of fraud. The implementation of the anomaly detection includes performing clustering on input transactions/data objects to group similar incoming transaction types, extracting for each input transaction/data object the details such as the process ids related to this set of data object, and extract the task sequence by traversing. The AI engine trains different ML algorithms for false positives (E.g., neural network/deep learning algorithms). The approval level optimization by AI engine enables automated routing of approvals depending on the criticality associated with the received data object. For example, the ML classification model can leverage the organizational hierarchy to route high-value invoices to managers for approvals and simple invoices get auto-approved but general invoices requiring attention get routed to financial analysts etc. The implementation of the Optimization includes extension of Machine learning classification model.

In an exemplary embodiment, the system may enable cognitive computing to improve interaction between a user and the enterprise application(s). The intelligent interface provides insight into dynamically changing parameters for execution of operation in spend control and budget management in SCM application.

The present invention uses Artificial intelligence and budget management support architecture where the entire operational logic in the service is transformed into engine reducing complex logic. The sequence flow is translated in the engine. It is very helpful to manage multitenant applications. Simulators also help to unit test the flow not only with in the bounded context but across applications with registered in the flow. The system provides building highly scalable services. The system includes both backend and frontend components (UI components, rules engine and workflow) that offers productivity gain and accelerates spend control and budget management implementation cycle.

In an embodiment of the present invention, any enterprise application (EA) operation requires a finite amount of processing time on a computer processor. Further, the accuracy of results or any process depends on how faster impact is analyzed for any application. The present invention restrains the process of generating a processing path as the fastest processing route for determining changes in functions, while simultaneously satisfying the needs of obtaining accurate results, data elements are organized/processed depending on the demands of the computing resources, which allow more functions of the one or more applications to be processed with same resources (e.g., disk space, processor speed, memory, etc.). For Eg., non-receipt of the order in time would impact status of the budget by not classifying the related PO as expensed part of the budget since the order has not been fulfilled yet. This would impact internal budget functions of other entities and the overall organization. The real time identification of the nodes or data blocks or processing path to incorporate impact of the change across spend control and budget management application may be carried out using the same resource (data store, data control tower, processor, controller). Thus, the net result of the claimed invention provides improved processing and functioning of the systems. The logical processes involved with the system define the improvement.

In an exemplary embodiment, the present invention may be a data processing system, a method, and/or a computer program product. The computer program product may include a computer readable storage medium (or media) having computer readable program instructions thereon for causing a processor to carry out aspects of the present invention. The media has embodied therein, for instance, computer readable program code (instructions) to provide and facilitate the capabilities of the present disclosure. The article of manufacture (computer program product) can be included as a part of a computer system/computing device or as a separate product.

The computer readable storage medium can retain and store instructions for use by an instruction execution device i.e., it can be a tangible device. The computer readable storage medium may be, for example, but is not limited to, an electromagnetic storage device, an electronic storage device, an optical storage device, a semiconductor storage device, a magnetic storage device, or any suitable combination of the foregoing. A non-exhaustive list of more specific examples of the computer readable storage medium includes the following: a hard disk, a random access memory (RAM), a portable computer diskette, a read-only memory (ROM), a portable compact disc read-only memory (CD-ROM), an erasable programmable read-only memory (EPROM or Flash memory), a digital versatile disk (DVD), a static random access memory (SRAM), a floppy disk, a memory stick, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the appended claims.

1. A data processing system comprising:
a processor; and
one or more memory devices including instructions that are executable by the processor for causing the processor to:
track, monitor and analyze, by the processor coupled to a data tracker, one or more datasets of a plurality of entities in real time wherein the one or more datasets stored in a real-time entity database are classified automatically by the processor based on attributes associated with the datasets to generate one or more classified datasets of at least one data control tower;
receive one or more data objects from at least one entity of the plurality of entities;
process by an Artificial Intelligence engine coupled to the processor, one or more data attributes associated with the one or more received data objects based on one or more data models stored in a data model database to automatically classify the one or more received data objects wherein the one or more data models are structured based on the one or more datasets; and
determine an impact of the one or more received data objects on the at least one data control tower through a data simulation thereby enabling informed readjustment of the one or more classified datasets and the at least one data control tower.

2. The system of claim 1, wherein the one or more memory devices further includes instructions that are executable by the processor for causing the processor to:
automatically feed, the one or more received data objects to a first data model to obtain an output from the first data model indicating whether a data attribute value associated with the one or more received data objects is greater than or less than a threshold value associated with the at least one data control tower.

3. The system of claim 2, wherein the one or more memory devices further includes instructions that are executable by the processor for causing the processor to:
automatically feed, the output from the first data model to a second data model to obtain an output from the second data model indicating an approval flow to be executed by the processor for the one or more received data objects.

4. The system of claim 3, wherein the one or more memory devices further includes instructions that are executable by the processor for causing the processor to:
in response to receiving the output from the second data model, generate a visual data object within a GUI through the data simulation to provide guidance on the impact of the one or more received data objects on the at least one data control tower.

5. The system of claim 4, wherein the one or more memory devices further includes instructions that are executable by the processor for causing the processor to:
automatically feed, an impact information to readjust the one or more classified datasets and the at least one data control tower on execution of the approval flow.

6. The system of claim 5, wherein the one or more memory devices further includes instructions that are executable by the processor for causing the processor to:
generate a revised version of the at least one data control tower and render by the processor the revised version within the GUI.

7. The system of claim 6, wherein the one or more memory devices further includes instructions that are executable by the processor for causing the processor to:
automatically determine the threshold value for the data attribute value by analyzing a historical data of the real time entity database used to generate the one or more classified datasets; and
automatically render visual data markers within the GUI indicating the threshold value for the data attribute value.

8. The system of claim 7, wherein the one or more memory devices further includes instructions that are executable by the processor for causing the processor to:
in response to determining the data attribute value as greater than the threshold value, automatically feed the impact information and the data attribute value to a third data model to obtain an output from the third data model indicating distribution of data attribute value over a time frame and generating by the processor a visible projection of the distribution within the GUI to provide the revised version of the at least one data control tower.

9. The system of claim 1 wherein the entities include at least one accounting entity of an organization including finance, HR, Legal, procurement, and cost incurring entity including at least one of direct cost incurring entity or indirect cost incurring entity.

10. The system of claim 9 wherein the classified dataset includes at least one of expensed cost dataset, obligated cost dataset and committed cost dataset.

11. The system of claim 10 wherein the at least one data control tower is a spend data control tower providing real time budget consumption data of each of the plurality of entities.

12. The system of claim 11 wherein the one or more received data objects includes at least one of a purchase request (PR) data object, a Purchase Order (PO) data object, an invoice data object, or one or more SCM scenario data requiring readjustment of the budget consumption data related to the one or more entities in the at least one data control tower.

13. The system of claim 12 wherein the one or more received data objects comprises a plurality of data attributes including at least one of cost, item details including quantity of item, supplier name, duration, and terms.

14. The system of claim 13 wherein the data simulation by a data simulator compares the plurality of data attributes of the received data objects with a threshold data and associated threshold value to determine the impact and readjust the at least one data control tower through a control mechanism.

15. The system of claim 14 wherein the expensed cost dataset includes costs related to goods or services already received or consumed by the one or more entities.

16. The system of claim 12 wherein the obligated cost dataset includes costs to be incurred to the one or more entities based on issued Purchase orders (PO).

17. The system of claim 12 wherein the committed cost dataset includes costs predicted to be incurred to the one or more entities based on generated purchase request (PR).

18. The system of claim 12 wherein the attributes of datasets and one or more data objects includes at least one of taxonomy associated to a document, sub class of the document, document Types, Application Types, Supplier location, Region of business, taxation attributes, Line attributes, clause type, approval type, document value, a date range/duration, accounting entity and cost.

19. The system of claim 18, wherein the processor generates a controller dashboard within the GUI enabling a user to run the data simulation on a requested PR data object to assess impact of the PR data object on a budget in case the PR data object is approved or rejected thereby enabling informed execution of the PR data object.

20. The system of claim 19 further comprises:
a control mechanism to process Purchase request (PR) data object for each entity based on the threshold value set for the at least one control tower.

21. The system of claim 20 further comprises a network communication to transmit to a remote system, the PR data object determined to be approved for generating a PO.

22. The system of claim 21, wherein an instruction to check budget by determining the impact comprises instructions configured to cause the processor to match one or more entities in the data object for identifying a virtual entity, match the data attributes of the one or more data objects for verification of the virtual entity, match extent of budget consumption in the at least one data control tower by checking for partial PO execution, checking for available funds from entity other than the identified virtual entity to capture actual real time budget consumption data and issue approval or rejection through an API.

23. The system of claim 12, further comprises:
an application server with a controller encoded with instructions enabling the controller to function as a bot configured to generate a plurality of fixtures for processing the received dataset by utilizing a library of functions stored on a functional database wherein the plurality of fixtures are backend scripts created by the bot based on the SCM scenario data, received data objects and AI processing for enabling automation of a data processing operation.

24. The system of claim 23 wherein the SCM scenario data includes modification to one or more data attributes of the data objects such as cancellation of item, modification of cost, change in entity or duration.

25. A data processing method comprises:
tracking, monitoring and analyzing, by a processor coupled to a data tracker, one or more datasets of a plurality of entities in real time wherein the one or more datasets stored in a real-time entity database are classified automatically by the processor based on attributes associated with the one or more datasets to generate one or more classified datasets of at least one data control tower;
receiving one or more data objects from at least one entity of the plurality of entities;
processing by an Artificial Intelligence engine coupled to the processor, one or more data attributes associated with the one or more received data objects based on one or more data models stored in a data model database to automatically classify the one or more received data objects wherein the one or more data models are structured based on the one or more datasets; and
determining an impact of the one or more received data objects on the at least one data control tower through a data simulation thereby enabling informed readjustment of the one or more classified datasets and the at least one data control tower.

26. The method of claim 25 further comprises:
automatically feeding by the processor, the one or more received data objects to a first data model to obtain an output from the first data model indicating whether a data attribute value associated with the one or more received data objects is greater than or less than a threshold value associated with the at least one data control tower.

27. The method of claim 26 further comprises:
automatically feeding by the processor, the output from the first data model to a second data model to obtain an output from the second data model indicating an approval flow to be executed by the processor for the one or more received data object.

28. The method of claim 27, further comprises:
in response to receiving the output from the second data model, generating by the processor, a visual data object within a GUI through the data simulation to provide guidance on the impact of the one or more received data objects on the at least one data control tower.

29. The method of claim 28, further comprises:
automatically feeding by the processor, an impact information to readjust the one or more classified dataset and the at least one data control tower on execution of the approval flow.

30. The method of claim 29, further comprises:
generating by the processor, revised version of the at least one data control tower and rendering by the processor the revised version within the GUI.

31. The method of claim 30, further comprises:
automatically determine the threshold value for the data attribute value by analyzing a historical data of the real time entity database used to generate the one or more classified datasets; and
automatically render visual data markers within the GUI indicating the threshold value for the data attribute value.

32. The method of claim 31, further comprises
in response to determining the data attribute value as greater than the threshold value, automatically feeding by the processor, the impact information and the data attribute value to a third data model to obtain an output from the third data model indicating distribution of data attribute value over a time frame and generating by the processor a visible projection of the distribution within the GUI to provide the revised version of the at least one data control tower.

33. The method of claim 25 wherein the one or more data objects is a text document, image document or a data entry through a user interface.

34. The method of claim 33 wherein a data attribute is extracted from the one or more data objects by a data extraction method, wherein the data extraction method comprises:
identifying a type of the one or more data objects;
sending the one or more data objects to at least one data recognition training model for identification of at least one data attribute wherein the data recognition training model processes the one or more data objects based on prediction analysis by a bot for obtaining the at least one data attribute with a confidence score;
drawing a bounded box around the at least one identified data attribute by a region of interest script;
cropping the at least one identified data attribute in the drawn box;
extracting one or more text data from the at least one identified data attribute by optical character recognition; and
validating the one or more text data after processing through an AI based data validation engine.

35. A non-transitory computer-readable medium storing computer-executable instructions that when executed by a computing device cause the computing device to:
track, monitor and analyze, by a processor coupled to a data tracker, one or more datasets of a plurality of entities in real time wherein the one or more datasets stored in a real-time entity database are classified automatically by the processor based on attributes associated with the datasets to generate one or more classified datasets of at least one data control tower;
receive one or more data objects from at least one entity of the plurality of entities;
process by an Artificial Intelligence engine coupled to the processor, one or more data attributes associated with the one or more received data objects based on one or more data models stored in a data model database to automatically classify the one or more received data objects wherein the one or more data models are structured based on the one or more datasets; and
determining an impact of the one or more received data objects on the at least one data control tower through a data simulation thereby enabling informed readjustment of the one or more classified datasets and the at least one data control tower.

36. A data processing system for real time spend control and budget management, the system comprising:
an entity machine configured to initiate at least one task to be performed for spend control and budget management;
an application server configured to receive input from the entity machine, the application server having a budget management support architecture for spend control and budget management, depending on the type of input received from the entity machine, the support architecture having:
a processor coupled to a data tracker to track, monitor and analyze, one or more datasets of a plurality of entities in real time wherein the one or more datasets stored in a real-time entity database are classified automatically by the processor based on attributes associated with the datasets to generate one or more classified datasets of at least one data control tower;
an AI engine coupled to the processor configured for processing one or more data attributes associated with at least one data object received from at least one entity of the plurality of entities based on one or more data models stored in a data model database to automatically classify the one or more received data objects wherein the one or more data models are structured based on the one or more datasets; and
a data simulator configured to determine an impact of the one or more received data objects on the at least one data control tower thereby enabling informed readjustment of the one or more classified datasets and the at least one data control tower.
